(19) United States
(12) Patent Application Publication
(10) Pub. No.: US 2025/0269459 A1
(43) Pub. Date: Aug. 28, 2025

(54) WELDING SPATTER PROTECTION DEVICE WITH INTEGRATED CLEANING SYSTEM

(71) Applicant: SMS GROUP S.P.A., Tarcento (IT)

(72) Inventors: Luca PETRI, Tarcento (IT); Marco VIDONI, Tarcento (IT)

(73) Assignee: SMS GROUP S.P.A., Tarcento (IT)

(21) Appl. No.: 19/060,227

(22) Filed: Feb. 21, 2025

(30) Foreign Application Priority Data
Feb. 26, 2024 (IT) 102024000004060

(51) Int. Cl. B23K 11/36

(52) U.S. Cl. CPC B23K 11/36

(57) ABSTRACT

A welding spatter protection device has a support structure, a movable structure delimiting a first internal cavity by internal side walls and movable by a first actuator between a lowered position, in which the first internal cavity is placed astride a welding zone, and a raised position, in which the first internal cavity is moved away from the welding zone, and a cleaning system having a scraper. Two second internal side walls interconnect two first internal side walls defining two concentric cylindrical surfaces. The scraper is connected to the movable structure by a support arm actuatable by a second actuator. Circumferential ends of the concentric cylindrical surfaces at an inlet mouth and at an internal stop position are radially aligned so that the scraper is always in contact with the concentric cylindrical surfaces, oriented so that a radially outermost cylindrical surface extends beyond the bottom wall, defining a shielding appendage.

### CROSS REFERENCE TO RELATED APPLICATION

This application claims priority to and benefit of Italian Patent Application No. 102024000004060 filed Feb. 26, 2024, the contents of which are incorporated by reference in their entirety.

### FIELD OF THE INVENTION

The present invention relates to a welding spatter protection device with integrated cleaning system.

Operatively, such a protection device is intended to be installed in machines for welding longitudinal metal products, in particular billets.

### PRIOR ART

As known, in the field of welding facilities for longitudinal metal products, such as billets, bars or blooms, welding is carried out by joining the head and tail of two consecutive metal products.

Generally, this type of welding is performed by sparking, conducting current into the products and approaching the head of one product and the tail of the other to each other so as to create a short circuit: the generated heat causes a melting of the metal resulting in the two ends being welded. Such a welding operation is performed directly on the metal product rolling line by means of welding machines provided with two structures equipped with clamps to block the two metal products to be welded. Both structures are mounted on a carriage moved at the advancement speed of the metal products along the rolling line. A first structure is fixed with respect to the carriage and the second structure instead slides so that the relative distance between the products to be welded can be varied until they come into contact.

Such a welding causes the generation of sparks resulting in the projection of molten steel particles (spatter or splashes), which hit the surrounding structures, depositing thereon with the risk of impairing the operation thereof. Furthermore, the accumulation of spatter can lead to the formation of deposits which can create dangerous electrical short circuits inside the machine itself over time.

In order to solve such problems, spatter containment devices to be installed in welding machines have been manufactured. Such devices comprise movable protection shields to be placed at the welding zone, as well as internal cleaning systems.

A welding spatter protection device is described in US patent application US20100721854A1. Such a protection device employs two protection shields which are moved by multiple linkages according to curvilinear trajectories to close the welding zone both at the top and at the bottom. The device is provided with a scraper sliding inside one of the two protection shields and a guillotine suitable to protect the scraper when not in operation. The protection shields have an open section for metal products to pass therethrough.

This solution, while operatively effective, has the disadvantage of being mechanically complex. Indeed, it requires the use of four actuators: two for the movement of the protection shields, one for the scraper and one for the guillotine.

A mechanically simpler welding spatter protection device is described in European patent EP3442738B1. Such a solution includes a single protection shield intended to enclose the welding zone only at the top.

In more detail, the protection shield consists of a box-like structure open at the bottom, in which a scraper is positioned. Two openings for the passage of products are obtained close to the open bottom, on two opposite side walls. The device is provided with a single actuator suitable to move the protection shield along a movement axis so that it is displaceable between a shielding position and a non-shielding position, while causing a relative movement between the scraper (fixed along the movement axis) and the internal walls of the protection shield, against which the scraper is in contact.

Such a solution is mechanically simpler and more compact by virtue of the presence of a single protection shield and a single actuator.

Generally, in welding machines, the metal products run on an external side of the machine. Therefore, the main structures of a welding machine are located substantially on one of the sides of the welding zone and partly thereabove. A collection and drainage channel for cooling water is positioned at the bottom of the welding zone.

The spatter projected toward the drainage channel and on the side opposite to where the main machine structures are located is uncapable of damaging the machine itself; therefore, it would be preferable not to intercept it with the protection device so as to ease the burden of internal cleaning. For this reason, it would be ideal to have a protection shield with asymmetric extension with respect to the welding zone, i.e., which extends thereabove and mainly on the side facing the main structures of the welding machine, while still ensuring sufficient protection for the operators' safety.

In the protection device described in EP3442738B1, the adoption of an asymmetric protection shield would result in axial asymmetry of the internal walls against which the scraper acts. Therefore, in its relative motion with respect to the protection shield, the scraper would be subjected to unbalanced mechanical stresses, which could cause uneven wear of the scraper over time, as well as misalignment of the scraper with the risk of jamming. This is a first limitation.

A second limitation is found in the presence of a single actuator and in the fact that the scraping is linked to the movement of the entire protection shield.

Due to the scraper wear, a single scraping pass may not be sufficient to remove all the spatter from the internal walls and therefore the operation needs to be repeated. This implies the need to approach the protection shield to the hot product repeatedly resulting in the protection shield being heated again. Heating the shield makes it easier for the hot steel spatter to stick to the shield, thus contributing to making the removal thereof more difficult.

Therefore, two needs are currently unmet in the corresponding technical field.

A first need is to optimize the efficacy of the protection device by adopting an asymmetric protection shield without however compromising the functionality of the scraper.

A second need is to perform a sequence of scraping cycles without necessarily promoting the spatter to stick to the shield walls due to heating thereof.

### SUMMARY OF THE INVENTION

Therefore, it is the main object of the present invention to eliminate all or part of the drawbacks of the prior art described above by providing a welding spatter protection device with an integrated cleaning system, which can be provided with an asymmetric protection shield without however compromising the functionality of the internal cleaning system.

It is a further object of the present invention to provide a welding spatter protection device with an integrated cleaning system which performing allows a sequence of scraping cycles without necessarily promoting the spatter to stick to the walls of the shield due to heating thereof.

In addition, it is a further object of the present invention to provide a welding spatter protection device with an integrated cleaning system which is cost-effective to manufacture.

Finally, it is a further object of the present invention to provide a welding spatter protection device with an integrated cleaning system which is operatively simple to manage.

### BRIEF DESCRIPTION OF THE DRAWINGS

The technical features of the present invention can be clearly found in the contents of the claims given below and the advantages thereof will become more apparent from the following detailed description, given with reference to the accompanying drawings, which show one or more embodiments thereof merely given by way of non-limiting examples, in which:

FIG. 1 diagrammatically depicts a side view of a welding machine equipped with a protection device according to a possible embodiment;

FIGS. 2 and 3 show two different perspective views of the protection device in FIG. 1, illustrated separate from the welding machine;

FIG. 4 shows an orthogonal side view of the device in FIG. 2 according to arrow IV here shown;

FIG. 5 shows an orthogonal side view of the apparatus in FIG. 2 according to arrow V here shown;

FIG. 6 shows an orthogonal section view of the device in FIG. 2 according to section plane L-L shown in FIG. 5, illustrated with the protection shield in the active position and a scraper of the integrated cleaning system in the disengaged position;

FIG. 7 shows an orthogonal side view of the device in FIG. 2 according to arrow VII here shown;

FIG. 8 shows the device in FIG. 4 illustrated with the protection shield in the passive position and the scraper of the integrated cleaning system in the engaged position;

FIG. 10 shows the device in FIG. 6 illustrated with the protection shield in the passive position and the scraper of the integrated cleaning system in the engaged position;

FIG. 11 shows an orthogonal section view of the device in FIG. 8 according to plane H-H here indicated; and

FIG. 12 shows an orthogonal section view of the device in FIG. 11 according to section plane XII-XII here indicated.

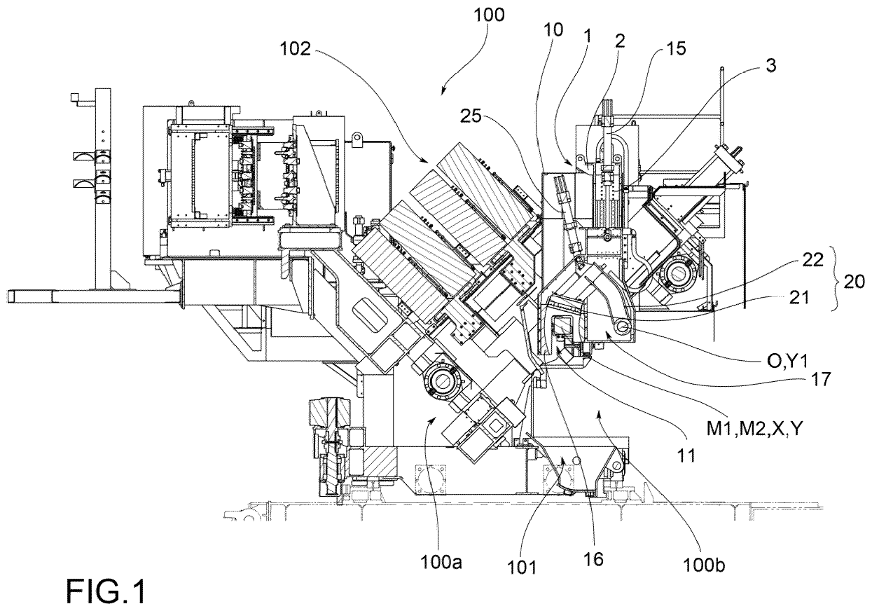

The elements or parts of elements common to the embodiments described below will be indicated by the same reference numerals.

### DETAILED DESCRIPTION OF THE INVENTION

The present invention relates to a welding spatter protection device with an integrated cleaning system.

Operatively, such a protection device is intended to be installed in machines for welding longitudinal metal products, in particular billets, but also bars or blooms which move aligned along an advancement axis X.

With reference to the accompanying drawings, a welding spatter protection device with an integrated cleaning system according to the invention is indicated by reference numeral 1 as a whole, and a welding machine provided with such a protection device is indicated by reference numeral 100.

Here and in the following description and claims, reference will be made to the protection device 1 in a condition of use. Any references to a lower or upper position, or to a horizontal or vertical orientation, must thus be understood in this sense.

According to a general embodiment of the present invention, the protection device 1 comprises a support structure 2 intended to be anchored to the welding machine 100 above the advancement axis X.

The protection device 1 further comprises a movable structure 10, which delimits a first internal cavity 11 for welding spatter shielding.

The movable structure delimits the first internal cavity 11 by means of a plurality of internal side walls 11a, 11b,11c,11d.

The first internal cavity 11 is accessible through an inlet mouth 12, defined by an opening which is obtained on a bottom wall 10a of the movable structure 10.

The opening obtained on the bottom wall 10a of the movable structure 10 extends with two recesses 13,14 to two first internal side walls 11a,11b of the plurality of internal side walls. Such two first internal side walls 11a, 11b are axially opposite to each other along an operating axis Y.

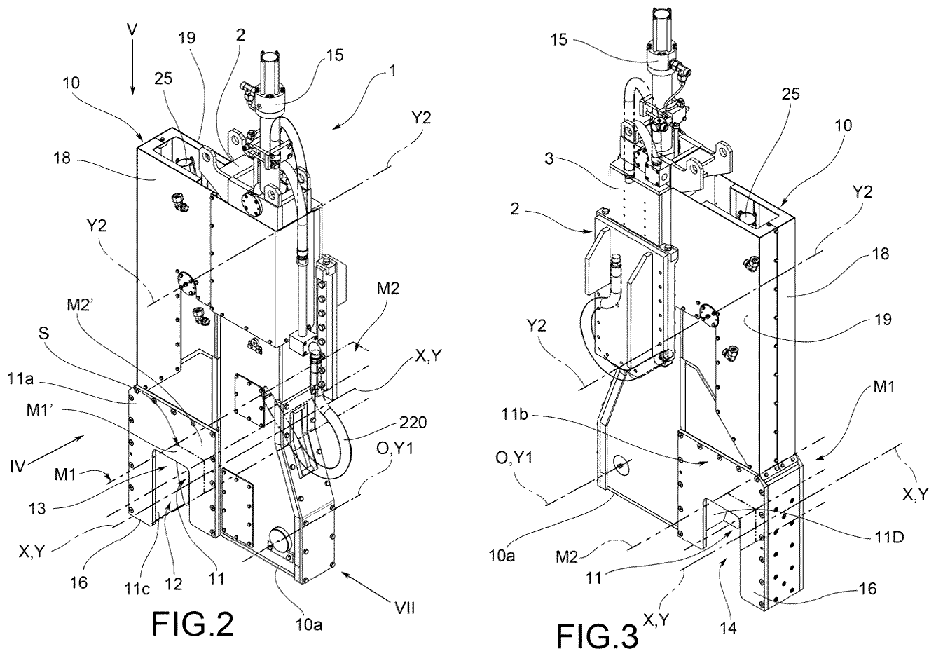

Operatively, as shown in FIGS. 2 and 3, through the inlet mouth 12 the first internal cavity 11 is suitable to receive the welding zone S therein between the ends M1′, M2′ of two metal products M1 and M2.

More in detail, the first internal cavity 11 receives the welding zone S therein when the two recesses 13, 14 are aligned with the advancement axis X of the metal products M, i.e., when the operating axis Y is substantially aligned with the advancement axis X of the metal products M1, M2. In this situation, each of the metal products M1, M2 crosses one of the two first internal side walls 11a, 11b at one of the two recesses 13, 14.

The movable structure 10 is movable with respect to the support structure 2 (and thus with respect to the welding machine 100 and the advancement axis X) by means of a first actuator 15 between:

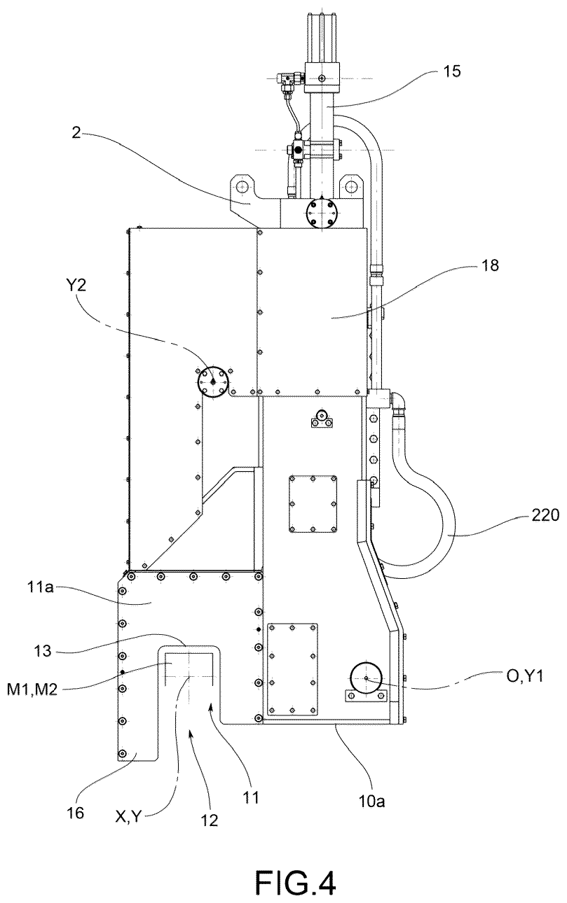

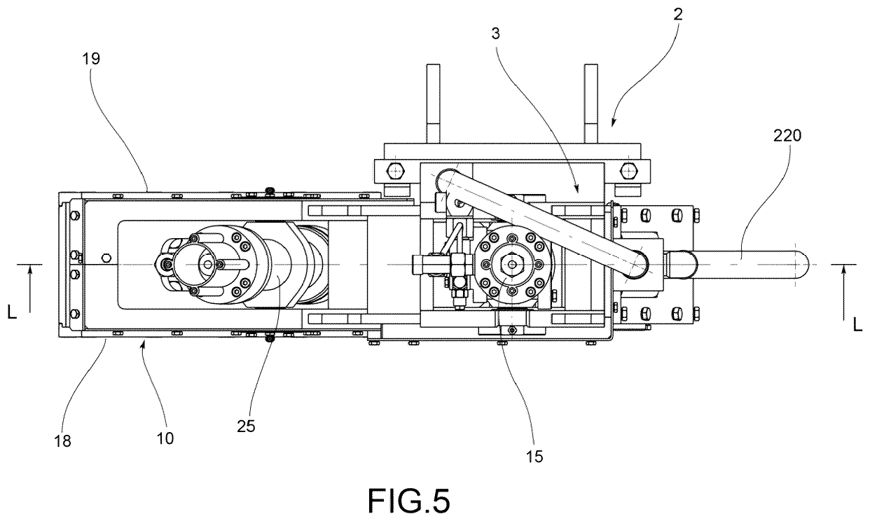

a lowered position, in which in use the first internal cavity 11 is placed astride the welding zone (see FIGS. 2, 3, 4, 6), and a raised position, in which in use the first internal cavity 11 is moved away from the welding zone (see FIGS. 8, 9, 10).

The protection device 1 further comprises a cleaning system 20 for cleaning the internal side walls 11a, 11b, 11c,11d of the first internal cavity from welding spatter.

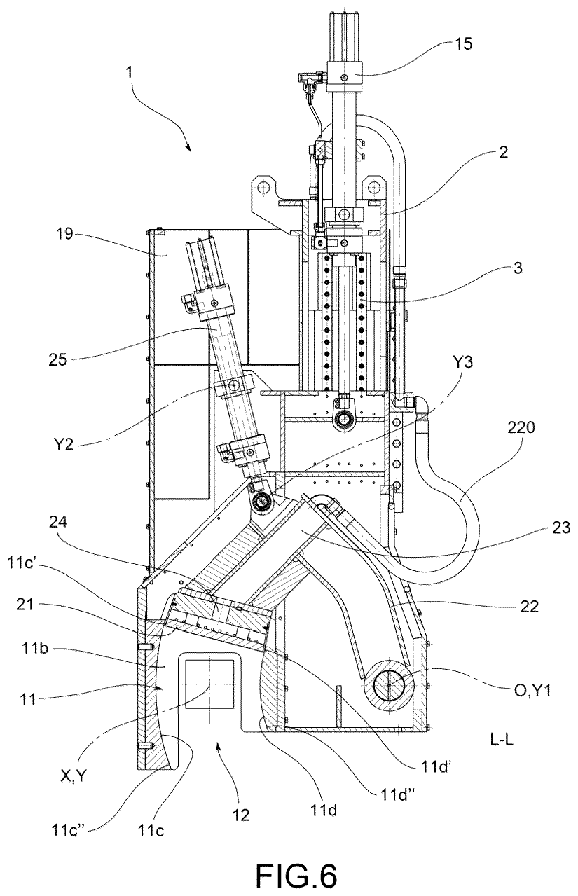

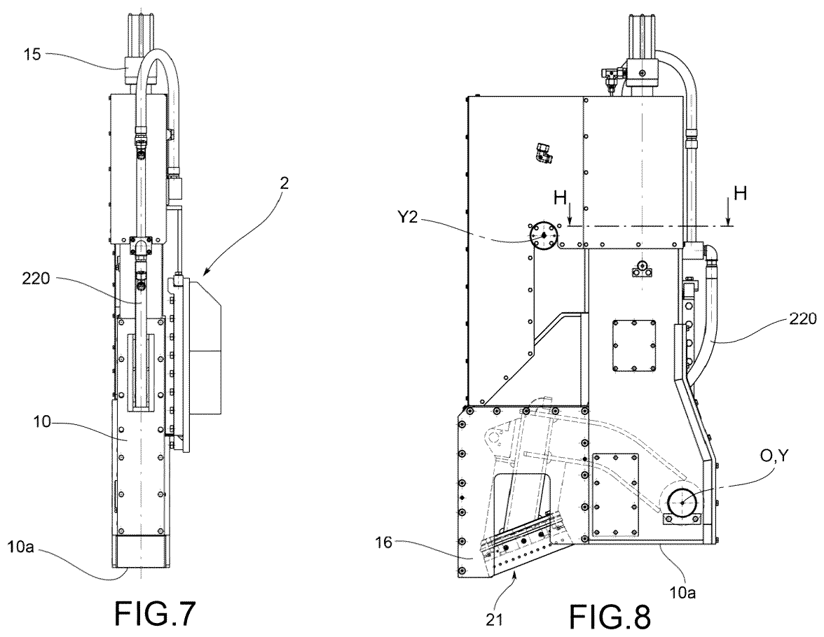

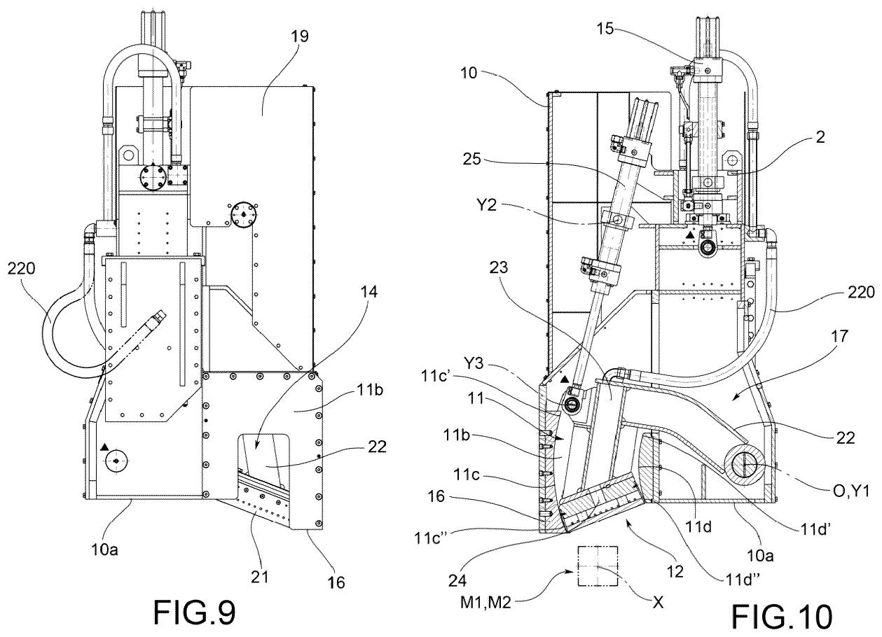

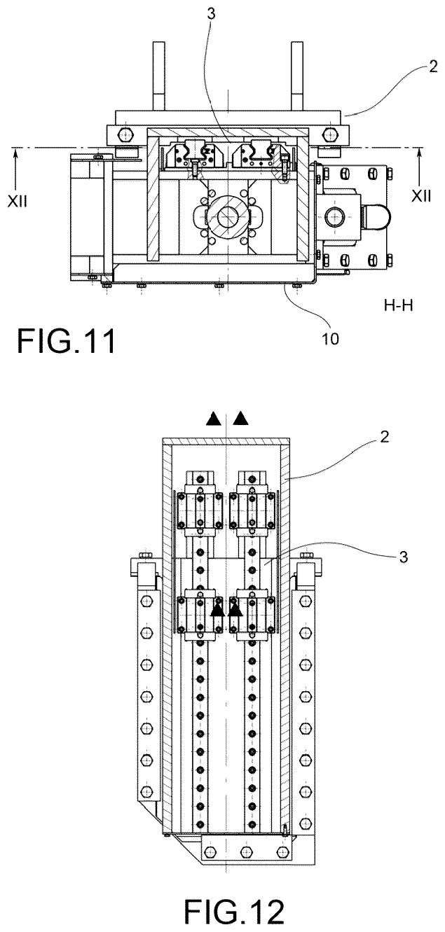

Such a cleaning system 20 comprises a scraper 21 which is movable with respect to the internal side walls 11a, 11b, 11c, 11d with interference relation between the inlet mouth 12 and an internal stop position (see FIGS. 6 and 10).

In particular, as shown in the accompanying figures, the first internal cavity 11 is delimited by:
two first internal side walls 11a, 11b, which extend transversely to the operating axis Y and on which the two recesses 13, 14 are obtained; and

two second internal side walls 11c,11d, which interconnect the two first internal side walls 11,11b to each other in the direction defined by the operating axis Y.

According to a first aspect of the present invention, the two second internal side walls 11c,11d interconnect the two first internal side walls 11a,11b to each other and define two concentric cylindrical surfaces.

Such two concentric cylindrical surfaces extend from the inlet mouth 12 to the internal stop position.

As shown in FIGS. 6 and 10, the central axis O of the two concentric cylindrical surfaces passes inside the movable structure 10.

Therefore, with respect to the central axis O, a radially outermost cylindrical surface 11c and a radially innermost cylindrical surface 11d can be identified.

According to a further aspect of the present invention, the scraper 21 is rotationally connected to the movable structure 10 by means of a support arm 22.

The support arm 22 is pivoted on a rotation axis Y1 coincident with the central axis O of the two concentric cylindrical surfaces 11c, 11d and supports the scraper 21, keeping it aligned on a radial plane with respect to the central axis O.

The support arm 22 is rotationally actuatable about the rotation axis Y1 (so as to move the scraper 21 inside the first internal cavity 11) by means of a second actuator 25.

In particular, the second actuator 25 consists of an electro-pneumatic or hydraulic piston.

In particular, the second actuator 25 is pivoted to the movable structure 10 in a first portion thereof to rotate about an axis Y2 and to the support arm 22 in a second portion thereof to rotate about an axis Y3. The second actuator 25 is thus capable of following the movements of the support arm 22 with respect to the movable structure 10.

According to a further aspect of the present invention, the circumferential ends 11c′, 11c″ and 11d′, 11d″ of the two concentric cylindrical surfaces 11c,11d are mutually radially aligned at the inlet mouth 12 and the internal stop position so that the scraper 21 is always in contact with the two concentric cylindrical surfaces 11c, 11d.

The two concentric cylindrical surfaces 11c,11d are oriented so that the radially outermost cylindrical surface 11c extends beyond the bottom wall 10a of the movable structure 10, defining a shielding appendage 16. In other words, the first internal cavity 11 defines an asymmetric protection shield about the operating axis Y (and thus about the advancement axis X when the movable structure 10 is in the lowered position in use).

The protection device 1, once positioned over the advancement axis X and then over the collection and drainage channel 101 for the cooling water of the machine, can thus be oriented so that the shielding appendage 16 faces the internal side of the welding machine, where the main structures 102 of the machine are located.

The first internal cavity 11 is thus:
open at the bottom above the drainage channel 101;
asymmetrically more laterally extended toward the internal side 100a of the welding machine 100 than toward the external side 100b by virtue of the shielding appendage 16 which extends downward from the bottom wall of the movable structure.

By virtue of such a conformation, the spatter projected toward the drainage channel 101 and on the side opposite to where the main structures 102 of the machine are located are not intercepted or are only partially intercepted, while ensuring sufficient protection for the operators' safety. It is thus possible to avoid unnecessarily “soiling” the protection screen with spatter uncapable of damaging the welding machine. On the contrary, the spatter projected toward the internal side 100a, where the main structures 102 of the machine are located, is instead shielded more effectively.

However, by virtue of the present invention, the adoption of an asymmetric protection shield does not compromise the functionality of the internal cleaning system.

Indeed, the scraper 21 is always in contact with the two concentric cylindrical surfaces 11c, 11d during its movement between the inlet mouth 12 and the internal stop position. Therefore, in its motion with respect to the internal side walls, the scraper is subjected to balanced mechanical stresses, meaning that the scraper is always in contact with the internal side walls throughout the peripheral extension thereof. This reduces the risk of uneven wear of the scraper over time, as well as the misalignment of the scraper with the risk of jamming.

Indeed, the curved conformation of the first internal cavity 11, in combination with the movement of the scraper 21, compensates for the asymmetry of the protection shield.

Furthermore, the welding spatter protection device with integrated cleaning system according to the present invention allows performing a sequence of scraping cycles without necessarily promoting spatter to stick to the walls of the shield due to the heating thereof.

By virtue of the present invention, and in particular by virtue of the scraper 21 being installed aboard the movable structure and being movable with respect thereto by means of its actuator 25, distinct from the first actuator 15 on the movable structure 10, it is possible to separate the two movements. Therefore, the scraper 21 can perform a sequence of scraping cycles when the movable structure 10 is in the raised position. The scraping can thus be performed repeatedly (by moving the scraper several times between the inlet mouth and the internal stop position) without approaching the movable structure to the welding zone, thus preventing it from heating up.

Preferably, the two concentric cylindrical surfaces 11c,11d are oriented so that the radially innermost cylindrical surface 11d ends at the bottom wall 10a of the movable structure 10. The exposure to spatter of the surface of the first internal cavity 11 arranged on the external side of the welding machine is thus minimized.

Advantageously, as shown in FIG. 6, the two concentric cylindrical surfaces 11c,11d extend circumferentially beyond the two recesses 13, 14 so that the scraper 21 is positioned above the two recesses when it reaches the internal stop position. Operatively, in this situation, the two recesses 13, 14 are free and can be engaged by the longitudinal metal products.

Preferably, the central axis O of the two concentric cylindrical surfaces 11c, 11d is parallel to the operating axis Y.

Preferably, the two first internal side walls 11a, 11b are flat and orthogonal to the operating axis Y.

Preferably, as shown in the accompanying figures, the two first internal side walls 11a, 11b extend in a direction orthogonal to the bottom wall 10a as much as the two concentric cylindrical surfaces 11c, 11d.

Advantageously, the movable structure 10 delimits a second internal cavity 17 in which the support arm 22 of the scraper 21 is housed and which is open on the first internal cavity 11 to allow the passage of the support arm 22.

The rotation axis Y1 of the support arm 22 of the scraper 21 coincides with the central axis O of the two concentric cylindrical surfaces and therefore preferably passes inside the movable structure 10. The rotation axis Y1 necessarily passes outside the first internal cavity, preferably inside the second internal cavity 17.

In the accompanying figures, the second actuator 25 is kinematically connected to the support arm 22 to define a third-degree lever. By virtue of the scraper actuator being distinct from the movable structure actuator, it is possible to choose the position of the second actuator 25 with respect to the scraper 21 and to the support arm pivot, so as to define a second-degree lever. In the latter case, the scraping effect obtained being equal, the applied force can be reduced or the actuator itself can be undersized.

In particular, the second internal cavity 17 is adjacent to the first internal cavity 11 and is separated from the latter by the internal side wall 11d which defines the radially innermost cylindrical surface.

Advantageously, the support arm 22 delimits an internal conduit 23 for feeding cooling water to the scraper 21, which in turn is provided with internal cooling channels 24 communicating with discharge holes. In the accompanying figures, the water supply tube is indicated by reference numeral 220.

Preferably, the first actuator 15 and the second actuator 25 are supported by the movable structure 10 above the first internal cavity 11 and the second internal cavity 17. The first and second actuators 15 and 25 are thus arranged in the part of the movable structure 10 furthest from the bottom wall 10a and thus least exposed to heat.

Advantageously, the movable structure 10 comprise a plurality of protective walls 18,19 for the first 15 and second 25 actuators.

According to the embodiment of the present invention shown in the accompanying figures, the movable structure 10 is defined by a box-like body, preferably defined by flat walls.

In particular, the flat walls of the box-like structure consist of removable panels to allow easier access to the mechanical components of actuators and scraper.

In particular, the two first internal side walls 11a, 11b are flat and define external portions of the box-like body.

In particular, the bottom wall 10a of the movable structure 10 is flat and defines an external portion of the box-like body.

Preferably, the bottom wall 10a is parallel to the operating axis Y.

Preferably, the movable structure 10 is connected to the support structure 2 by means of at least one linear guiding device 3 suitable to guide the movement of the movable structure 10 between the lowered position and the raised position.

In particular, the protection device 1 is intended to be installed on the welding machine 100 so that the bottom wall 10a is horizontal. The movement between the raised position and the lowered position occurs according to a longitudinal direction orthogonal to the bottom wall, i.e., vertical.

The present invention relates to a welding machine 100 provided with a welding spatter protection device 1 according to the invention and in particular as described above. The welding spatter protection device 1 is installed in the machine so that the shielding appendage 16 is arranged on an internal side 110b of the welding machine 100 where the main structures 102 of the machine itself are installed.

The present invention further relates to a method of shielding from welding spatter in a welding machine for longitudinal metal products moving aligned along an advancement axis X.

The method comprises the following operating steps:
a) installing a welding splatter protection device 1 according to the present invention, and in particular as described above, in the welding machine 100;
b) bringing the movable structure 10 to the lowered position by actuating the first actuator 15, having previously brought the scraper 21 to the internal stop position by actuating the second actuator 25;
c) welding;
d) bringing the movable structure 10 from the lowered position to the raised position by actuating the first actuator 15; and
e) carrying out one or more cleaning cycles of the first internal cavity 11 by moving the scraper 21 once or more times between the internal stop position and the inlet mouth 12 of the first internal cavity 11 by actuating the second actuator 25.

The advantages of the shielding method according to the present invention are apparent from the above description in connection with the device and will not be repeated here.

The present invention allows achieving several advantages which have been set out in the description.

The welding spatter protection device 1 with integrated cleaning system according to the present invention can be provided with an asymmetric protection shield without however compromising the functionality of the internal cleaning system.

The welding spatter protection device 1 with integrated cleaning system according to the present invention allows performing a sequence of scraping cycles without necessarily promoting spatter to stick to the walls of the shield due to the heating thereof.

The welding spatter protection device 1 with integrated cleaning system according to the present invention is cost-effective to manufacture.

The welding spatter protection device 1 with integrated cleaning system according to the present invention is operatively simple to manage.

Therefore, the present invention thus devised achieves the preset objects.

Obviously, in practice, it may also take shapes and configurations different from that disclosed above, without departing from the scope of protection as described and claimed herein.

Moreover, all details may be replaced by technically equivalent elements, and any size, shape, and material may be used according to needs.

1. A protection device from welding splatter installable on a welding machine for longitudinal metal products moving aligned along an advancement axis, the protection device comprising:
a support structure configured to be anchored to the welding machine above the advancement axis;
a movable structure, which delimits a first internal cavity by a plurality of internal side walls, the first internal cavity being accessible by an inlet mouth defined by an opening on a bottom wall of the movable structure and extends with two recesses to two first internal side walls of the plurality of internal side walls axially opposite along an operating axis, wherein through the inlet mouth the first internal cavity is configured to receive therein a welding zone between ends of two metal products, aligning the two recesses with the advancement axis, the movable structure being movable with respect to the support structure by a first actuator between a lowered position, in which, in use, the first internal cavity is astride the welding zone, and a raised position, in which, in use, the first internal cavity is moved away from the welding zone, and
a cleaning system for cleaning the internal side walls of the first internal cavity from the welding splatter, the cleaning system comprising a scraper movable with respect to the internal side walls in an interference relation between the inlet mouth and an internal stop position,
wherein two second internal side walls of the plurality of internal side walls interconnect the two first internal side walls to each other and define two concentric cylindrical surfaces extending from the inlet mouth to the internal stop position,
wherein the scraper is rotationally connected to the movable structure by a support arm which is pivoted on a rotation axis coincident with a central axis of the two concentric cylindrical surfaces and supports the scraper, keeping the scraper aligned on a radial plane, the support arm being actuatable by a second actuator, and
wherein circumferential ends of the two concentric cylindrical surfaces at the inlet mouth and at the internal stop position are radially aligned so that the scraper is always in contact with the two concentric cylindrical surfaces, the two concentric cylindrical surfaces being oriented so that a radially outermost cylindrical surface extends beyond the bottom wall of the movable structure, defining a shielding appendage.

2. The protection device of claim 1, wherein the two concentric cylindrical surfaces are oriented so that a radially innermost cylindrical surface ends at the bottom wall of the movable structure.

3. The protection device of claim 1, wherein the two concentric cylindrical surfaces extend circumferentially beyond the two recesses so that the scraper, when the scraper reaches the internal stop position in a stop position, is positioned above the two recesses.

4. The protection device of claim 1, wherein the central axis of the two concentric cylindrical surfaces is parallel to the operating axis.

5. The protection device of claim 2, wherein the movable structure delimits a second internal cavity within which the support arm of the scraper is housed and which is open on the first internal cavity to allow passage of the support arm.

6. The protection device of claim 5, wherein the second internal cavity is adjacent to the first internal cavity and separated from the first internal cavity by the internal side wall which defines the radially innermost cylindrical surface.

7. The protection device of claim 1, wherein the support arm delimits an internal conduit for feeding cooling water to the scraper, the internal conduit comprising internal cooling channels communicating with discharge holes.

8. The protection device of claim 5, wherein the first actuator and the second actuator are supported by the movable structure above the first internal cavity and the second internal cavity.

9. The protection device of claim 8, wherein the movable structure comprises protective walls for the first and second actuators.

10. The protection device of claim 1, wherein the two first internal side walls are flat and orthogonal to the operating axis.

11. The protection device of claim 1, wherein the movable structure is defined by a box-like body.

12. The protection device of claim 11, wherein the two first internal side walls are flat and define external portions of the box-like body.

13. The protection device of claim 11, wherein the bottom wall is flat and defines an external portion of the box-like body.

14. The protection device of claim 13, wherein the bottom wall is parallel to the operating axis.

15. The protection device of claim 1, wherein the movable structure is connected to the support structure by at least one linear guiding device configured to guide a movement of the movable structure between the lowered position and the raised position.

16. A welding machine comprising the protection device of claim 1, wherein the protection device is installed in the welding machine so that the shielding appendage is arranged on an internal side of the welding machine where main structures of the welding machine are installed.

17. A method for shielding from welding splatter in a welding machine for longitudinal metal products moving aligned along an advancement axis, the method comprising:
a) installing a protection device comprising:
a support structure configured to be anchored to the welding machine above the advancement axis;
a movable structure, which delimits a first internal cavity by a plurality of internal side walls, the first internal cavity being accessible by an inlet mouth defined by an opening on a bottom wall of the movable structure and extends with two recesses to two first internal side walls of the plurality of internal side walls axially opposite along an operating axis, wherein through the inlet mouth the first internal cavity is configured to receive therein a welding zone between ends of two metal products, aligning the two recesses with the advancement axis, the movable structure being movable with respect to the support structure by a first actuator between a lowered position, in which, in use, the first internal cavity is placed astride the welding zone, and a raised position, in which, in use, the first internal cavity is moved away from the welding zone, and
a cleaning system for cleaning the internal side walls of the first internal cavity from the welding splatter, the cleaning system comprising a scraper movable with respect to the internal side walls in an interference relation between the inlet mouth and an internal stop position,
wherein two second internal side walls of the plurality of internal side walls interconnect the two first internal side walls to each other and define two concentric cylindrical surfaces extending from the inlet mouth to the internal stop position,
wherein the scraper is rotationally connected to the movable structure by a support arm which is pivoted on a rotation axis coincident with a central axis of the two concentric cylindrical surfaces and supports the scraper, keeping the scraper aligned on a radial plane, the support arm being actuatable by a second actuator, and
wherein circumferential ends of the two concentric cylindrical surfaces at the inlet mouth and at the internal stop position are radially aligned so that the scraper is always in contact with the two concentric cylindrical surfaces, the two concentric cylindrical surfaces being oriented so that a radially outermost cylindrical surface extends beyond the bottom wall of the movable structure, defining a shielding appendage;
b) bringing the movable structure to the lowered position by actuating the first actuator, having previously brought the scraper to the internal stop position by actuating the second actuator;
c) welding;
d) bringing the movable structure from the lowered position to the raised position by actuating the first actuator; and
e) performing one or more cleaning cycles of the first internal cavity by moving the scraper between the internal stop position and the inlet mouth of the first internal cavity by actuating the second actuator.

18. The protection device of claim 1, wherein the movable structure is defined by flat walls.
